(19) United States
(12) Patent Application Publication
(10) Pub. No.: US 2017/0201144 A1
(43) Pub. Date: Jul. 13, 2017

(54) BRUSHLESS MOTOR

(71) Applicant: TOKYO PARTS INDUSTRIAL CO., LTD., Gunma-ken (JP)

(72) Inventor: Masahiro NISHIDATE, Gunma-ken (JP)

(21) Appl. No.: 15/398,076

(22) Filed: Jan. 4, 2017

(30) Foreign Application Priority Data
Jan. 11, 2016 (JP) 20016-214486
Jan. 28, 2016 (JP) 2016-014115

(51) Int. Cl. H02K 5/22

(52) U.S. Cl. CPC H02K 5/225

(57) ABSTRACT

Top face lands are formed on the top face of a circuit board, and bottom face lands are formed on the bottom face of the circuit board. The top face lands are disposed radially inward of a cylinder part of a cover member, and when viewed from axially above, the top face lands are hidden by the cover member such that they cannot be seen. The bottom face lands are disposed axially above the bottom face of the retaining plate, and do not protrude from the bottom face of the retaining plate. Viewed from the radial direction, a first cutaway is formed in the cylinder part of the cover member. Viewed from axially below, a second cutaway is formed in the retaining plate. When a circuit member is taken out in the radial direction, the circuit member is fastened to the top face lands, via the first cutaway, and when the circuit member is taken out in the axially downward direction, the circuit member is fastened to the bottom face lands, via the second cutaway.

### BACKGROUND OF THE INVENTION

The present invention relates to a brushless motor comprising a cover member that covers a rotor and a stator.

Brushless motors exist in which the rotor and the stator are covered by a cover member, in order to prevent dust and the like from penetrating into the motor.

When such brushless motors are fastened in various types of devices, depending on the device, a lead wire (circuit member) connected to the motor terminals may lead out in an axial direction, parallel to the rotary shaft of the motor, or may lead out in a radial direction, perpendicular to the rotary shaft of the motor. Thus, if motors are prepared having terminals that protrude in different directions it is possible to mount the motors in various types of devices, but this has presented the problem of increasing the number of motor models.

As one proposal for solving this problem, for example, in Japanese Patent Laid-Open Publication No. S57-071245, an invention is proposed in which terminal pieces protrude in both the axial direction of the motor and the radial direction of the motor, and whichever terminals are unnecessary are removed using a punch die. With this invention, a single motor can support situations in which, when the motor is mounted, the directions in which the lead wires lead out differ depending on the counterpart device.

However, with Japanese Patent Laid-Open Publication No. S57-071245, while the number of motor models did not increase, there was a risk of lowering motor quality because, when one of the sets of terminal pieces was removed, the other terminal pieces tended to be deformed.

### SUMMARY OF THE INVENTION

One or more embodiments of the present invention solve the problems of the prior art described above and provide a motor with which either of the two directions, which is to say, the axial direction or the radial direction, can be chosen as the direction in which the circuit member leads out, without leading to a loss of quality. Note that, in the aspects described below, the constituent elements employed can be used in the most freely chosen combinations possible. Furthermore, the aspects and technical features of the present invention are not limited to those described hereafter, and are to be understood based on the description in the entire specification and the drawings, or based on the inventive ideas that can be grasped by the skilled artisan on the basis of these descriptions.

A first aspect of the present invention relating to a brushless motor comprises: a rotor;

a stator arranged facing the rotor;

a cover member that covers the rotor and the stator and has a cylinder part and a cover part provided at the top end of the cylinder part;

a retaining plate fastened to an open end of the cylinder part;

a circuit board fastened to the top face of the retaining plate; and

a circuit member connected to the circuit board,

wherein,

top face lands and bottom face lands are formed on the circuit board;

a first cutaway is formed in the cylinder part, and when the circuit member leads out in the radially outward direction, the circuit member is connected to the top face lands and leads out through the first cutaway; and

a second cutaway is formed in the retaining plate, in a part corresponding to the bottom face lands, and when the circuit member leads out in the axially downward direction, the circuit member is connected to the bottom face lands, and leads out through the second cutaway.

In a second aspect of the present invention,

the first cutaway is formed at the open end of the cylinder part.

In a third aspect of the present invention,

a protrusion, which protrudes in the radial direction, is formed at the outer edge of the circuit board; and

the protrusion is inserted into the first cutaway, and when viewed from axially above, does not protrude from the cylinder part.

In a fourth aspect of the present invention,

when viewed from axially below, a gap is formed between the protrusion and the cylinder part.

In a fifth aspect of the present invention,

the circuit member leads out in the radially outward direction; and

a gap is formed between the circuit member and the first cutaway.

In a sixth aspect of the present invention,

the rotor is disposed above the top face lands; and

the axial height from the top face lands to the top end of the first cutaway is less than the axial height from the top face lands to the bottom end of the rotor.

In a seventh aspect of the present invention,

the second cutaway is formed at the outer edge of the retaining plate.

In an eighth aspect of the present invention,

the first cutaway is formed at the open end of the cylinder part;

the second cutaway is formed at the outer edge of the retaining plate; and

the first cutaway and the second cutaway are disposed so as to overlap in the circumferential direction.

### BRIEF DESCRIPTION OF THE DRAWINGS

FIG. 1 shows a brushless motor according to a first exemplary mode of embodiment, in which no circuit member is connected; (a) is a front view, (b) is a bottom view, and (c) is a view in the direction of the arrows at the line A-A in (a).

FIG. 2 is a sectional view taken in the direction of the arrows at the line B-B in FIG. 1 (a).

FIG. 3 shows the brushless motor according to the first exemplary mode of embodiment; (a) is a side view with the circuit member leading out in the radially outward direction; and (b) is a side view with the circuit member leading out in the axially downward direction.

FIG. 4 is a sectional view of a brushless motor according to a second exemplary mode of embodiment.

### DETAILED DESCRIPTION OF THE PREFERRED EMBODIMENTS

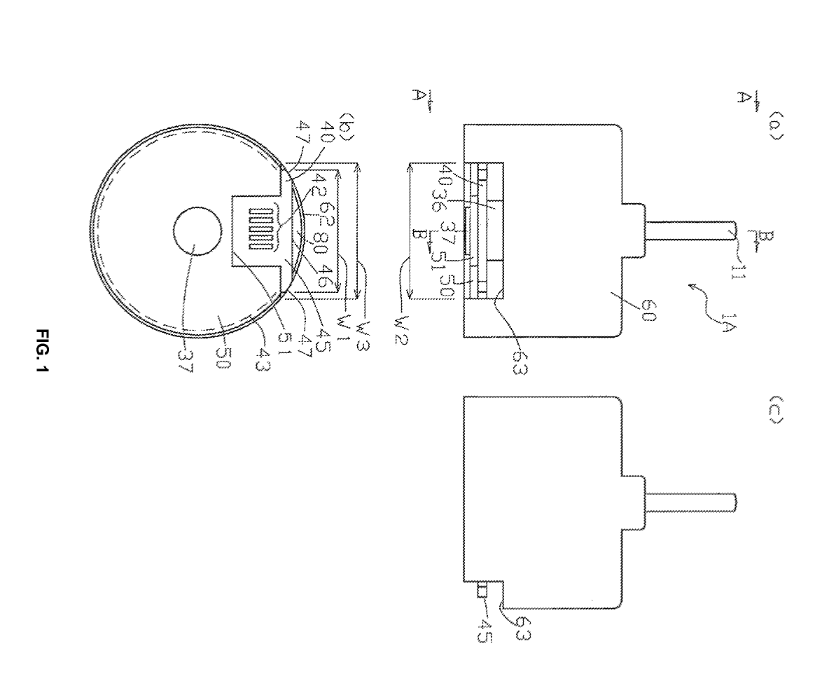

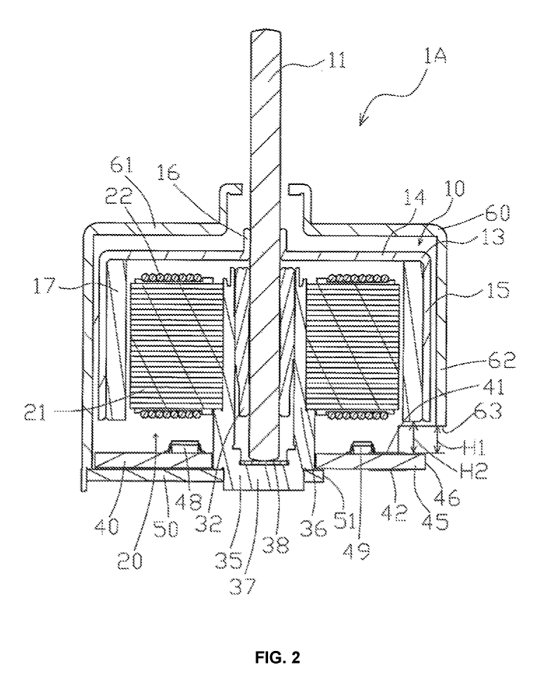

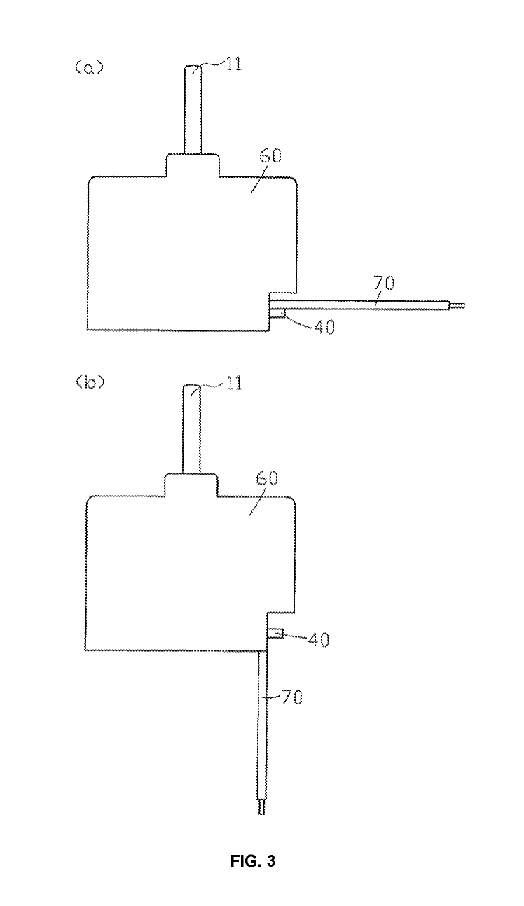

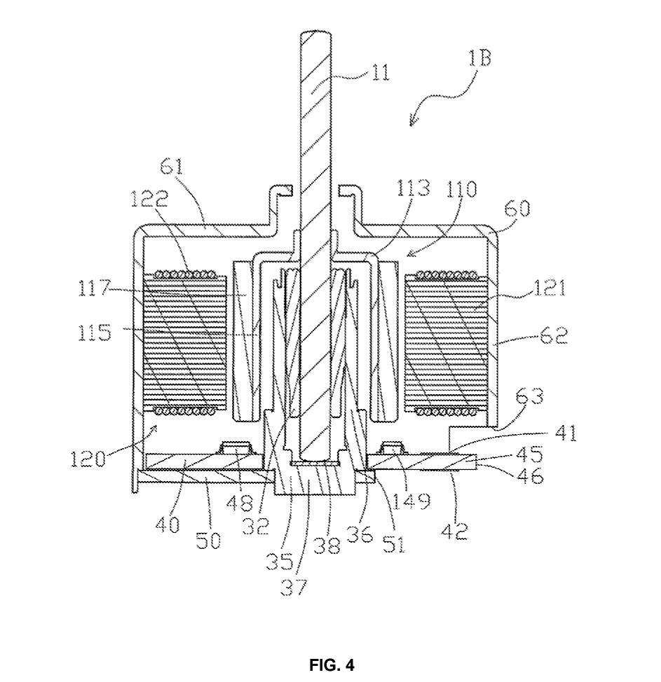

In the present specification, upward in the direction of the rotary shaft of the motor in FIG. 1 (a), FIG. 1 (c), FIG. 2, FIG. 3 and FIG. 4 is referred to simply as “upward” and downward therein is referred to simply as “downward.” Note that, the upward and downward directions do not indicate positional relationships or directions when the actual device is assembled. Furthermore, the direction parallel to the rotary shaft is referred to as the “axial direction,” the radial direction having the rotary shaft as its center is referred to simply as the “radial direction,” and the circumferential direction having the rotary shaft as its center is referred to simply as the “circumferential direction.”

Hereinafter modes of embodiment of the present invention are illustratively described based on the drawings.

### First Exemplary Mode of Embodiment

The configuration of an outer rotor type brushless motor 1A according to the first exemplary mode of embodiment of the present invention is described using FIG. 1 to FIG. 3.

As shown in FIG. 2, the brushless motor 1A in this example comprises a rotor 10, a rotary shaft 11, a stator 20, a bearing 32, a bearing holder 35, a circuit board 40, a retaining plate 50, and a cover member 60.

The rotor 10 comprises a rotor case 13 and a rotor magnet 17.

The stator 20 comprises a stator core 21 and coils 22.

The bearing 32 serves to support the rotary shaft 11 in the radial direction and comprises a cylindrical oil impregnated sintered body, serving as a sliding bearing.

The bearing holder 35 has a circular cylindrical cylinder part 36 and a bottom 37. A thrust receiving member 38, which receives the load of the rotary shaft 11, is disposed on the top face of the bottom 37. The bearing 32 is fastened to the inner circumferential face of the cylinder part 36.

The rotary shaft 11 is supported by the bearing 32 and the bearing holder 35 so as to be able to rotate around the vertical direction, the rotary shaft 11 being formed from metal, in the shape of an elongate cylinder.

The rotor case 13 rotates united with the rotary shaft 11. This rotor case 13 has a circular cylindrical cylinder part 15 and a disk shaped cover part 14, provided at the top end of the cylinder part 15, a drive rotor magnet 17 being fastened to the inner circumferential face of the cylinder part 15. The bottom end of the rotor magnet 17 and the bottom end of the cylinder part 15 of the rotor case 13 are disposed at the same height in the axial direction. A burring part 16, which results from drawing, rises upward in the center of the cover part 14 of the rotor case 13. The rotary shaft 11 is fastened by way of press fitting into this burring part 16.

The stator 20 is disposed so as to radially face the rotor magnet 17. Specifically, the stator 20 has a stator core 21 that is fastened to the outer circumferential face of the cylinder part 36 of the bearing holder 35, and is disposed so as to radially face the inner circumferential face of the rotor magnet 17.

The stator core 21 serves to strengthen the magnetic flux when current is passed through the coils 22. The stator core 21 is made from a laminate in which a plurality of core plates are laminated, and has a plurality of equidistant salient poles at the outer circumference thereof. Coils 22 are respectively wound on each of the salient poles.

The rotor magnet 17 is disposed facing the salient polls on the stator core 21, and generates a rotational force in the rotor 10. The rotor magnet 17 is formed in the shape of a ring, and is alternatingly magnetized with North and South poles, in the circumferential direction.

The retaining plate 50 is a member that closes the open end (bottom end) of a cover member 60, which is described hereafter. The retaining plate 50 is made from metal and formed in a deformed disk shape, in which a portion is cut away so as to form a second cutaway 51, which is described hereafter. The retaining plate 50 is formed expanding radially outward from the bottom 37 of the bearing holder 35, and the outer diameter of the retaining plate 50 is formed larger than the outer diameter of the cylinder part 15 of the rotor case 13.

The cover member 60 covers the rotor 10 and the stator 20 from above, and serves to prevent dust and the like from penetrating into the motor. The cover member 60 is formed from a hard material, and has a circular cylindrical cylinder part 62, and a disk shaped cover part 61, provided at the top end of the cylinder part 62. Thus, when the retaining plate 50 is inserted into the open end of the cylinder part 62, the outer circumference of the retaining plate 50 is fastened to the open end of the cylinder part 62.

A first cutaway 63 is formed in the open end of the cylinder part 62 of the cover member 60, for taking the circuit member 70 out in the radially outward direction. When viewed from the radial direction, the first cutaway 63 is rectangular, and formed with a width W2. When viewed from axially below, this width W2 corresponds to an opening angle of approximately 80 degrees, centered on the rotary shaft 11.

The cover part 61 of the cover member 60 serves as a mounting face for mounting the brushless motor 1A on a device, and thus the cover part 61 of the cover member 60 is provided with holes for mounting screws (not shown).

The circuit board 40 is formed in a plate shape, and has a deformed circular part 43, in which a portion of the disk is cut away, slightly smaller than the outer diameter of the cover member 60, and a protrusion 45, which protrudes in the radial direction from the outer edge of the deformed circular part 43. When viewed from axially below, the protrusion 45 is rectangular, and has a width W1.

The width W1 of the protrusion 45 is formed smaller than the width W2 of the first cutaway 63.

When the circuit board 40 is fastened to the top face of the retaining plate 50, the protrusion 45 protrudes radially outward from the outer circumference of the retaining plate 50.

The circuit board 40 and the retaining plate 50 have through holes in the approximate centers thereof, having the same circular form as the outer circumferential face of the bearing holder 35, and the bottom 37 of the bearing holder 35 is fastened in these through holes.

The circuit board 40 comprises a known printed board (PWB, PCB or the like) and has top face lands 41 and bottom face lands 42. The circuit member 70, which is described hereafter, is connected to either one of the top face lands 41 or the bottom face lands 42 alone.

Five top face lands 41 and five bottom face lands 42 are provided, and these are respectively electrically connected to each other via non-illustrated through holes provided in the circuit board 40.

These five lands are, for example, a connection terminal, a power source voltage terminal, a rotational speed signal terminal, a pulse width modulation signal terminal, and a rotor 10 forward/reverse rotation signal terminal, and are electrically connected to a motor control IC 48, which is fastened to the circuit board 40.

When viewed from axially above, the top face lands 41 are disposed radially inward of the cylinder part 62 of the cover member 60.

The axial height H1 from the top face lands 41 to the top end of the first cutaway 63 is less than the axial height H2 from the top face lands 41 to the bottom end of the rotor 10.

A through hole is formed in the center of the cover part 61 of the cover member 60, and the rotary shaft 11 protrudes upward through this through hole. The upwardly protruding rotary shaft 11 is fastened, for example, to a non-illustrated drive gear or the like. The rotary shaft 11 does not make contact with the cover part 61.

A detection element 49, which is a Hall IC and serves to detect the rotational position of the rotor 10, is fastened on the top face of the circuit board 40, facing the rotor 10, the output terminals of the detection element 49 being connected to the motor control IC 48.

Furthermore, the output terminals of the motor control IC 48 are connected to the terminals of the coils 22.

The rectangular second cutaway 51 is formed at the outer edge of the retaining plate 50, for taking the circuit member 70 out in the axially downward direction. The second cutaway 51 is formed in a portion corresponding to the bottom face lands 42 and is larger than the bottom face lands 42. When viewed from axially below, the width W3 of the second cutaway 51 corresponds to an opening angle of approximately 80 degrees, centered on the rotary shaft 11. When the circuit board 40 is fastened in contact with the top face of the retaining plate 50, the bottom face lands 42 are disposed overlapping the second cutaway 51. When viewed from axially below, the bottom face lands 42 are exposed to the exterior of the motor by the second cutaway 51. The bottom face lands 42 are disposed axially above the bottom face of the retaining plate 50.

The retaining plate 50 that fastens the circuit board 40 is fastened in the open end of the cylinder part 62 of the cover member 60. At this time, the left and right ends 47 of the protrusion 45 are inserted into the first cutaway 63. However, when viewed from axially above, the left and right ends 47 of the protrusion 45 do not protrude beyond the cylinder part 62 of the cover member 60.

Furthermore, when viewed from axially below, the first cutaway 63 and the second cutaway 51 are disposed overlapping in the circumferential direction. When viewed from axially below, a first gap 80 is formed between a central portion 46 of the protrusion 45 and the cylinder part 62 of the cover member 60.

The circuit member 70 is a lead wire having connection terminals at each end, and serves to connect the motor control IC 48 to the terminals of an external circuit (not shown).

The circuit member 70 is fastened by soldering to one of the top face lands 41 or the bottom face lands 42 alone.

If the circuit member 70 is taken out in the radial direction, as shown in FIG. 3 (a), the circuit member 70 is connected to the top face lands 41, and leads out to the exterior of the motor, without bending, through the first cutaway 63. The external configuration of the circuit member 70 is such that, when viewed from the radial direction, this is formed smaller than the first cutaway 63, such that a second gap is formed between the circuit member 70 and the first cutaway 63.

If the circuit member 70 is taken out in the axially downward direction, as shown in FIG. 3 (b), the circuit member 70 is fastened to the bottom face lands 42, and leads out to the exterior of the motor, without bending, through the second cutaway 51.

With the brushless motor 1A in this example, when power is supplied from the external circuit to the motor control IC 48 via the circuit member 70, the coils 22 are excited and the rotor 10 rotates.

As described above, with the brushless motor 1A in this example, the top face lands 41 and the bottom face lands 42 are formed on the top face and the bottom face of the circuit board 40, respectively.

The top face lands 41 are disposed radially inward of the cylinder part 62 of the cover member 60, and when viewed from axially above, the top face lands 41 are hidden by the cover member 60 such that they cannot be seen, and do not protrude radially outward from the cylinder part 62 of the cover member 60.

The bottom face lands 42 are disposed axially above the bottom face of the retaining plate 50, and do not protrude from the bottom face of the retaining plate 50.

The first cutaway 63 is formed in the cylinder part 62 of the cover member 60, and the second cutaway 51 is formed in the retaining plate 50, in the part corresponding to the bottom face lands 42.

The circuit member 70 is connected to only one of the top face lands 41 or the bottom face lands 42. That is to say, when the circuit member 70 leads out in the radially outward direction, the circuit member 70 is connected to the top face lands 41 and leads out through the first cutaway 63. Meanwhile, when the circuit member 70 leads out in the axially downward direction, the circuit member 70 is connected to the bottom face lands 42, and leads out through the second cutaway 51.

With the brushless motor 1A in this example, the circuit member 70 leads out from only one of the top face lands 41 or the bottom face lands 42, depending on the device in which this brushless motor 1A is to be mounted, and thus a motor can be realized in which the circuit member 70 leads out in different directions. Furthermore, the configuration is such that the other lands, on which the circuit member 70 is not fastened, do not protrude below the retaining plate 50, or do not protrude radially outward from the cylinder part 62 of the cover member 60.

Consequently, a motor in which the circuit member 70 leads out in different directions can easily be manufactured without using a punch die, as in the conventional example, such that it is possible to prevent deformation of the lands on which the circuit member 70 is fastened, and thus improve motor quality.

Furthermore, the first cutaway 63 is formed at the open end of the cylinder part 62 of the cover member 60, and the second cutaway 51 is formed at the outer edge of the retaining plate 50.

Furthermore, when viewed from axially below, the first cutaway 63 and the second cutaway 51 are disposed overlapping in the circumferential direction.

Accordingly, the motor can easily be assembled by assembling the cover member 60 and the retaining plate 50, while looking at the first cutaway 63 and the second cutaway 51.

Furthermore, the protrusion 45, which protrudes in the radial direction, is formed at the outer edge of the circuit board 40, and the width W1 of this protrusion 45 is formed smaller than the width W2 of the first cutaway 63. Thus, the protrusion 45 is inserted into the first cutaway 63, and when viewed from axially above, the protrusion 45 does not protrude beyond the cylinder part 62 of the cover member 60.

Furthermore, the protrusion 45 is disposed so as to overlap the second cutaway 51 in the circumferential direction.

Thus, the protrusion 45 serves as a guide for the first cutaway 63, which facilitates assembly of the motor.

Furthermore, the circuit member 70 that leads out in the radial direction, is formed with the same continuous height in the radial direction.

Furthermore, the rotor 10 is disposed above the top face lands 41.

Furthermore, the axial height H1 from the top face lands 41 to the top end of the first cutaway 63 is formed lower than the axial height H2 from the top face lands 41 to the bottom end of the rotor 10.

Accordingly, the circuit member 70 that is fastened to the top face lands 41 does not make contact with the rotor 10, and thus this does not lead to loss of durability.

Furthermore, when viewed from the radial direction, the external configuration of the circuit member 70 is smaller than the configuration of the first cutaway 63. Accordingly, when the circuit member 70 is fastened to the top face lands 41, via the first cutaway 63, heat within the motor can escape to the outside of the motor, through the second gap, which is described above.

Furthermore, when viewed from axially below, the first gap 80 is formed between the central portion 46 of the protrusion 45 and the cylinder part 62 of the cover member 60. Accordingly, when the circuit member 70 is fastened to the bottom face lands 42, via the second cutaway 51, heat within the motor can escape to the outside of the motor through at least the first gap 80.

### Second Exemplary Mode of Embodiment

Next, the configuration of a brushless motor 1B according to a second exemplary mode of embodiment of the present invention is described by way of FIG. 4.

In FIG. 4, parts that are the same as parts in FIG. 1 to FIG. 3 are given the same reference numerals, and description of these parts is omitted.

In this example, the configuration of the rotor differs from that in the first exemplary mode of embodiment. That is to say, the first exemplary mode of embodiment was an outer rotor type brushless motor, covered by a cover member 60, but this example is an inner rotor type brushless motor covered by a cover member 60.

In this example, a rotor magnet 117 is fastened to the outer circumferential face of a cylinder part 115 of a rotor case 113, and a stator 120 has a stator core 121, fastened to the inner circumferential face of the cylinder part 62 of the cover member 60, the stator core 121 being disposed facing the outer circumferential face of the rotor magnet 117, in the radial direction. Note that a detection element 149 is disposed on the circuit board 40, in a position facing the rotor magnet 117.

The brushless motor 1B in this example achieves the same effect as the brushless motor 1A in the first exemplary mode of embodiment, and because this has an inner rotor, the rotor startup time can be shortened as compared to the case of an outer rotor.

Two exemplary modes of embodiment of the present invention have been described above, but the present invention is not limited to these exemplary modes of embodiment, and various modifications are possible.

Specifically, the first cutaway 63 may be formed as a through hole that does not adjoin the open end of the cylinder part 62, and the second cutaway 51 may be formed as a through hole that does not adjoin the outer edge of the retaining plate 50.

Furthermore, in the foregoing description, the first cutaway 63 and the second cutaway 51 were disposed so as to fully overlap in the circumferential direction, but the first cutaway 63 and the second cutaway 51 may be arranged so as to partially overlap in the circumferential direction, or may be arranged so as not to overlap at all.

Furthermore, a band shaped FFC (flexible flat cable) or FPC (flexible printed circuit) having a plurality of connection terminals at both ends, or a circuit member having connector terminals at both ends, may be used for the circuit member 70. If a circuit member having connector terminals is used, connectors that connect with the connector terminals are connected in advance with the top face lands 41 and the bottom face lands 42.

What is claimed is:

1. A brushless motor comprising:
a rotor;
a stator arranged facing the rotor;
a cover member that covers the rotor and the stator and has a cylinder part and a cover part provided at the top end of the cylinder part;
a retaining plate fastened to an open end of the cylinder part;
a circuit board fastened to the top face of the retaining plate; and
a circuit member connected to the circuit board,
wherein:
the bottom face lands are disposed axially above the bottom face of the retaining plate;
a first cutaway is formed in the cylinder part, and when the circuit member leads out in the radially outward direction, the circuit member is connected to the top face lands and leads out through the first cutaway; and
a second cutaway is formed in the retaining plate, in a part corresponding to the bottom face lands, and when the circuit member leads out in the axially downward direction, the circuit member is connected to the bottom face lands, and leads out through the second cutaway.

2. The brushless motor according to claim 1, wherein:
the first cutaway is formed at the open end of the cylinder part.

3. The brushless motor according to claim 2, wherein:
a protrusion, which protrudes in the radial direction, is formed at the outer edge of the circuit board;
the protrusion is inserted into the first cutaway, and when viewed from axially above, does not protrude from the cylinder part.

4. The brushless motor according to claim 3, wherein
when viewed from axially below, a gap is formed between the protrusion and the cylinder part.

5. The brushless motor according to claim 2, wherein:
the circuit member leads out in the radially outward direction; and
a gap is formed between the circuit member and the first cutaway.

6. The brushless motor according to claim 5, wherein:
the rotor is disposed above the top face lands; and
the axial height from the top face lands to the top end of the first cutaway is less than the axial height from the top face lands to the bottom end of the rotor.

7. The brushless motor according to claim 1, wherein
the second cutaway is formed at the outer edge of the retaining plate.

8. The brushless motor according to claim 1, wherein:
the first cutaway is formed at the open end of the cylinder part;
the second cutaway is formed at the outer edge of the retaining plate; and
the first cutaway and the second cutaway are disposed so as to overlap in the circumferential direction.

9. The brushless motor according to claim 8, wherein:
a protrusion, which protrudes in the radial direction, is formed at the outer edge of the circuit board; and
the protrusion is inserted into the first cutaway, and when viewed from the axially above, does not protrude from the cylinder part.

10. The brushless motor according to claim 9, wherein
when viewed from axially below, a gap is formed between the protrusion and the cylinder part.
